(19) United States
(12) Patent Application Publication
(10) Pub. No.: US 2020/0398918 A1
(43) Pub. Date: Dec. 24, 2020

(54) LIGHTWEIGHT ELECTRIC SADDLE TYPE VEHICLE CHASSIS

(71) Applicant: FUELL Inc., New York, NY (US)

(72) Inventors: Erik Buell, Mukwonago, WI (US); Edward Matthew Laben, Mukwonago, WI (US); Daniel David Hurda, Mequon, WI (US)

(21) Appl. No.: 16/903,805

(22) Filed: Jun. 17, 2020

Related U.S. Application Data
(60) Provisional application No. 62/863,078, filed on Jun. 18, 2019.

(51) Int. Cl. B62J 1/08; B62J 43/13; B62J 43/28; B62J 9/10; B62J 6/03; B62J 3/12; B62K 19/36; B62K 19/32; B62M 6/60; B62M 6/90

(52) U.S. Cl. CPC B62J 1/08; B62J 43/13; B62J 43/28; B62J 9/10; B62M 6/90; B62J 3/12; B62K 19/36; B62K 19/32; B62M 6/60; B62J 6/03

(57) ABSTRACT

A saddle type vehicle having at least one seat and at least two wheels, at least one electric motor, and a rechargeable electric energy storage system (RESS). The vehicle having a chassis that is formed from a first side frame member and a second side frame member to form a hollow interior. The chassis being configurable to support a pedaled configuration and a non-pedaled configuration utilizing the same chassis. The chassis forming a battery compartment and storage compartment that are accessible from an upper surface of the chassis. The chassis also extends from a forward end of the vehicle to a rear end of the vehicle such that the rear wheel connects to the rear end of the chassis and a steering stem attaches near the forward end of the chassis.

### CROSS-REFERENCE TO RELATED APPLICATIONS

This application claims priority to U.S. Provisional Patent Application No. 62/863,078 filed on Jun. 18, 2019. The above referenced application is incorporated by reference in its entirety.

### BACKGROUND

With the advent of advances in rechargeable energy storage systems (RESS) and electric motor technologies combined with society's desire to replace internal combustion vehicles more environmentally conscious alternatives, electric vehicles are being considered for all types of wheeled transportation. Motorcycles comprise the largest number of powered vehicles in the world, however electric powered bicycles are a rapidly growing segment as well. Electric bicycles may provide an affordable and environmentally friendly option for urban commuting.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to one aspect of this disclosure may relate to an electric saddle type vehicle that includes a chassis having a forward end and a rear end opposite the forward end, where the chassis includes: (a) a first side frame member extending from the forward end to the rear end, where the first side frame member includes a first portion of a seat support tower, and a first frame extension member at the rear end of the chassis; and (b) a second side frame member extending from the forward end to the rear end, where the second side frame member includes a second portion of the seat support tower. The first side frame member and the second side frame member may be joined together to form a battery compartment, a storage compartment, and the seat support tower. In addition, a steering stem may be attached near the forward end of the chassis, where handlebars are attached to the steering stem; and a rear wheel may be attached to the rear end of the chassis. The rear wheel maybe connected to an electric hub motor. The first side frame member may be a unitary single member, and similarly, the second side frame member may be a unitary single member. The first side frame member and the second side frame member may each be formed from a magnesium alloy. Additionally, the first side frame member and the second side frame member may form a majority of exterior surfaces of the chassis. Steering mount supports may be secured in between the first side frame member and the second side frame member when the first side frame member and the second side frame member are connected together, where the steering mount supports receive the steering stem. The battery compartment may be accessed through a battery compartment opening on an upper surface of the chassis. A storage compartment may be accessed through a storage compartment opening on an upper surface of the chassis. A battery or rechargeable energy storage system may be mounted in the battery compartment by installing the rechargeable energy storage system through the battery compartment opening, and a battery compartment cover may be secured over the battery compartment opening. In some examples, a spacer may be attached to the battery or rechargeable energy system prior to the battery being installed into the battery compartment. The forward end of the chassis may include a forward recess formed from the first side frame member and the second side frame member, wherein the forward recess is forward of the steering stem. A removable headlight and speaker module may be received in the forward recess. The seat support tower receives a first insert to provide a bicycle type seat for a pedaled configuration, and the seat support tower receives a second insert to provide a motorcycle seat for a non-pedaled configuration. As another option, the wiring and the brake lines may be routed from the handlebars to the steering stem, where the wiring and the brake lines exit the steering stem through an opening in the steering stem into a channel arranged in an internal cavity of the chassis. A handlebar cover may be mounted over the handlebars to protect the wiring and the brake lines attached to the handlebars.

Other aspects of this disclosure may relate to an electric saddle type vehicle that has a chassis having a forward end and a rear end opposite the forward end, where the rear end of the chassis extends aft of a seat. The chassis may be configured to support a pedaled configuration and a non-pedaled configuration of the electric saddle type vehicle. The chassis may include: (a) a first side frame member extending from the forward end to the rear end, where the first side frame member includes a first portion of a seat support mounting area and a first frame extension member, and (b) a second side frame member extending from the forward end to the rear end, where the first side frame member includes a second portion of the seat support mounting area. The first side frame member and the second side frame member may connect together to form a battery compartment, a storage compartment, and the seat support mounting area, and a steering stem may be attached near the forward end of the chassis. The first frame extension member may be releasably attached to the first side frame member, where the first frame extension member connects to an electric hub motor and a rear wheel. A frame extension member cover may connect to the first frame extension member and cover a recess on an inward facing surface of the frame extension member. When the chassis is configured in the pedaled configuration, a cartridge containing a pedal shaft and bearings may be connected to the chassis, where the cartridge may include a concentrically mounted electric motor. Alternatively, when the chassis is configured in the non-pedaled configuration, footboards may be connected to the chassis. The seat may be supported by a seat support tower that is releasably connected to the chassis at the seat support mounting area, where the seat support tower may be formed from a first seat support tower member and a second seat support tower member. In addition, the seat support tower is different for the pedaled configuration than the non-pedaled configuration.

### BRIEF DESCRIPTION OF THE DRAWINGS

The present invention is illustrated by way of example and not limited in the accompanying figures in which like reference numerals indicate similar elements and in which:

FIG. 1 illustrates a rear left side perspective view of an example of an electric saddle type vehicle with a step-through type design in a non-pedaled configuration with an exemplary mannequin showing a rider position according to aspects described herein.

FIG. 2 illustrates a front left side perspective view of an example of an electric saddle type vehicle of FIG. 1 in a pedaled configuration according to aspects described herein.

FIG. 3 illustrates a front left side perspective view of the electric saddle type vehicle of FIG. 2 with a left side frame member highlighted according to aspects described herein.

FIG. 4 illustrates a front left side perspective view of the electric saddle type vehicle of FIG. 2 with a right side frame member highlighted according to aspects described herein.

FIG. 5 illustrates a partial front left side perspective view of the electric saddle type vehicle of FIG. 2 according to aspects described herein.

FIG. 6 illustrates a rear left side perspective view of the electric saddle type vehicle of FIG. 2 with a left side frame member removed to show internal components according to aspects described herein.

FIG. 7 illustrates a partial front left perspective view of the electric saddle type vehicle of FIG. 2 with left side frame member removed according to aspects described herein.

FIG. 8 illustrates a partial front left perspective view of the electric saddle type vehicle of FIG. 2 according to aspects described herein.

FIG. 9 illustrates a partial front left perspective view of the pedaled vehicle of FIG. 2 with the rear frame extension highlighted according to aspects described herein.

FIG. 10 illustrates a top perspective view of the electric saddle type vehicle of FIG. 1 according to aspects described herein.

FIG. 11 illustrates a top perspective view of the electric saddle type vehicle of FIG. 1 with battery and storage doors removed according to aspects described herein.

FIG. 12 illustrates a front left perspective view of the electric saddle type vehicle of FIG. 1 with left side frame member removed and with a first battery and a first spacer according to aspects described herein.

FIG. 13 illustrates a front left perspective view of the electric saddle type vehicle of FIG. 1 with left side frame member removed and with a second battery and a second spacer according to aspects described herein.

FIG. 14 illustrates a front left perspective view of the electric saddle type vehicle of FIG. 1 with left side frame member removed and with a plurality of batteries according to aspects described herein.

FIG. 15 illustrates a partial front left perspective view of the electric saddle type vehicle of FIG. 1 with left side frame member removed according to aspects described herein.

FIG. 16 illustrates a partial front left perspective view of the electric saddle type vehicle of FIG. 1 according to aspects described herein.

FIG. 17 illustrates a partial front left perspective view of an alternate electric saddle type vehicle in a non-pedaled configuration with a left side seat support tower highlighted according to aspects described herein.

FIG. 18 illustrates a partial front left perspective view of the electric saddle type vehicle of FIG. 17 with the left side seat support tower removed and the right side seat support tower highlighted according to aspects described herein.

FIG. 19 illustrates a partial front left perspective view of the electric saddle type vehicle of FIG. 17 the seat support tower removed according to aspects described herein.

FIG. 20 illustrates a partial front left perspective view of the electric saddle type vehicle of FIG. 17 with the right side seat support tower installed according to aspects described herein.

FIG. 21 illustrates a partial front left perspective view of the electric saddle type vehicle of FIG. 17 with both the right side seat support tower and the left side seat support tower installed according to aspects described herein.

FIG. 22 illustrates a front left perspective view of the electric saddle type vehicle of FIG. 1 in a pedaled configuration according to aspects described herein.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

In general, aspects of this invention relate to an electric saddle type vehicle 10 that has a unique monocoque chassis 42 that supports the vehicle 10, while also providing substantial volume for an RESS or battery and storage. This monocoque type of chassis 42 design attains strength and stiffness through an optimized chassis shape around a hollow interior. The chassis 42 may be constructed primarily from two halves comprising a left side frame member 42A and a right side frame member 42B. Each side frame member 42A, 42B may include structural ribbing on the inside of each of them while maintaining a relative thin wall structure, where the majority of the wall thickness of each side frame member 42A, 42B may be within a range of 2 mm and 4 mm to minimize the overall weight and cost of the vehicle 10. The chassis 42 may secure single or multiple batteries (RESS) as well as different electric motors. The chassis 42 may support a single seat vehicle with a pedaled configuration and also can be used for a vehicle with footpegs or footboards in place of the pedals in a non-pedaled configuration. The chassis 42 may also secure a steering mount support(s) 52 between the side frame members 42A, 42B, such that these high stress areas may be of a higher strength material than the material forming the side frame members 42A, 42B. For example, the side frame members 42A, 42B may be formed from a magnesium alloy, aluminum alloy, titanium alloy, carbon fiber construction, or other polymeric material, while the steering mount supports 52 may be formed from a steel alloy. Because of the unitary construction of the side frame members 42A, 42B, the chassis 42 may be about 20 percent of the overall weight of the vehicle 10, or within a range of 15 percent and 25 percent of the overall weight of the vehicle 10.

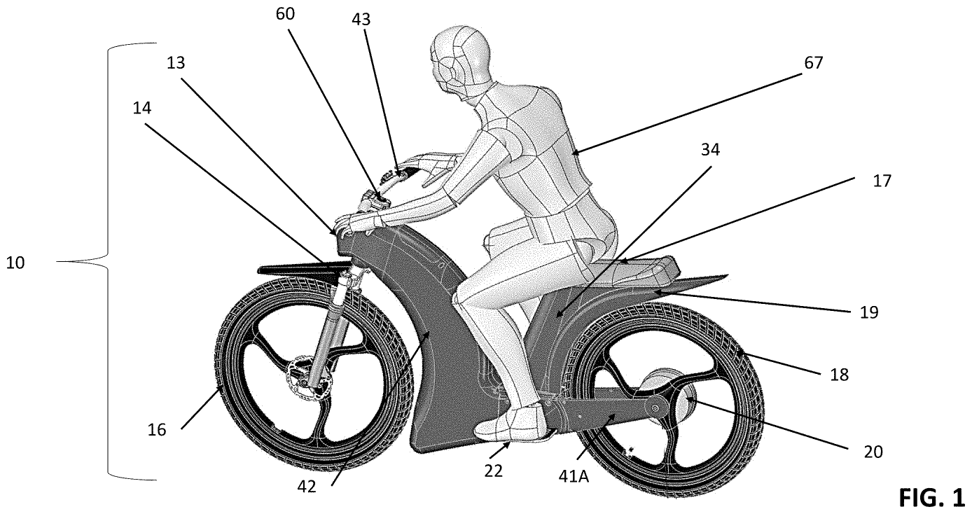

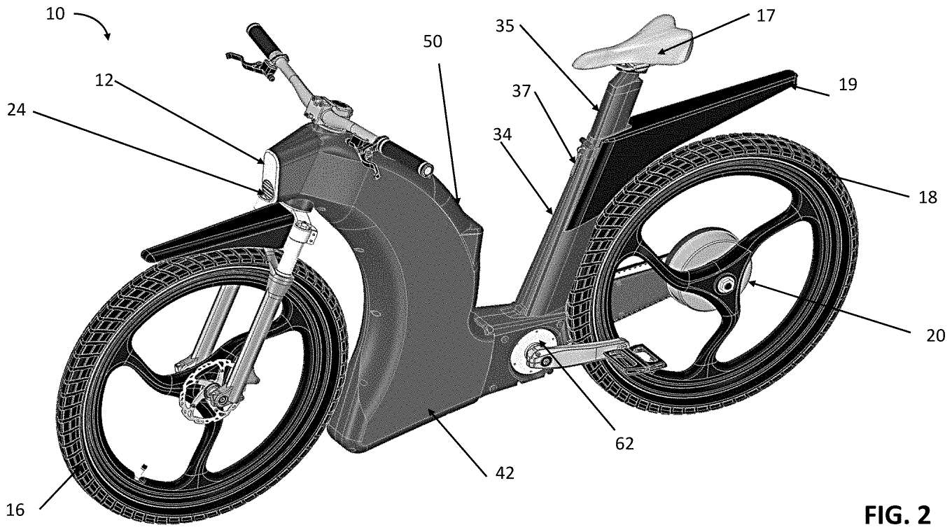

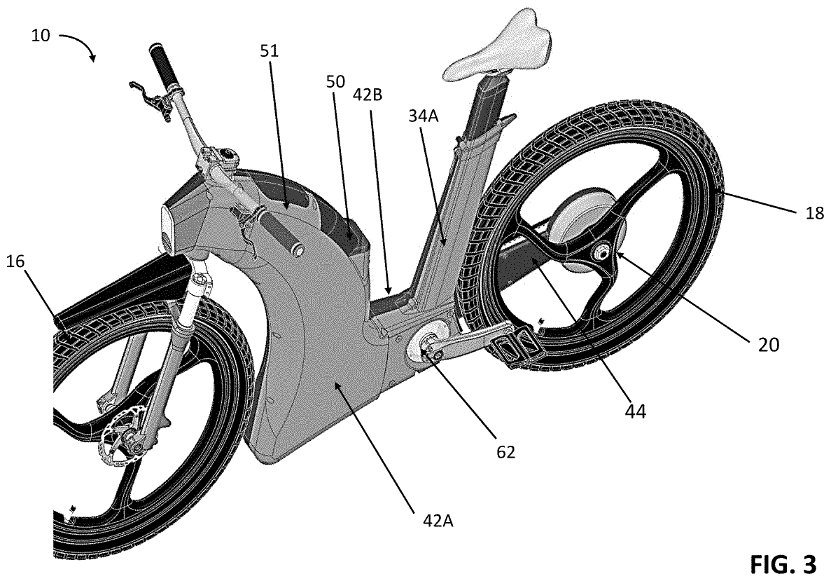

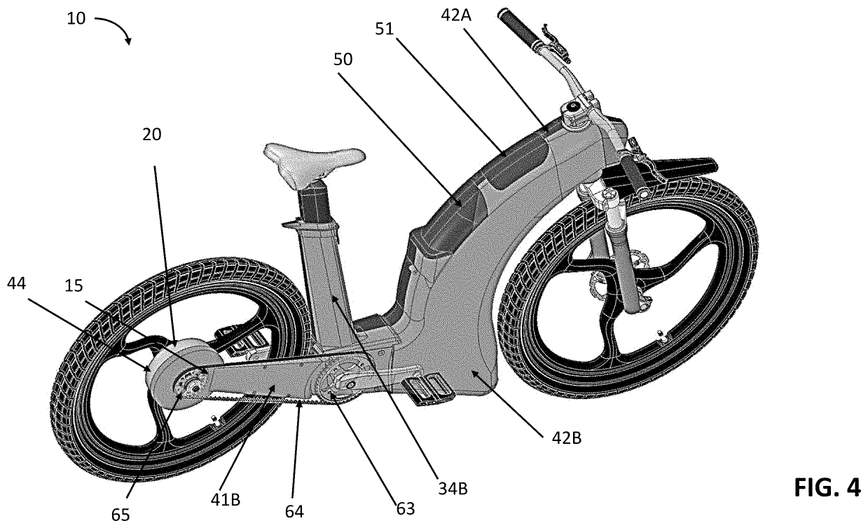

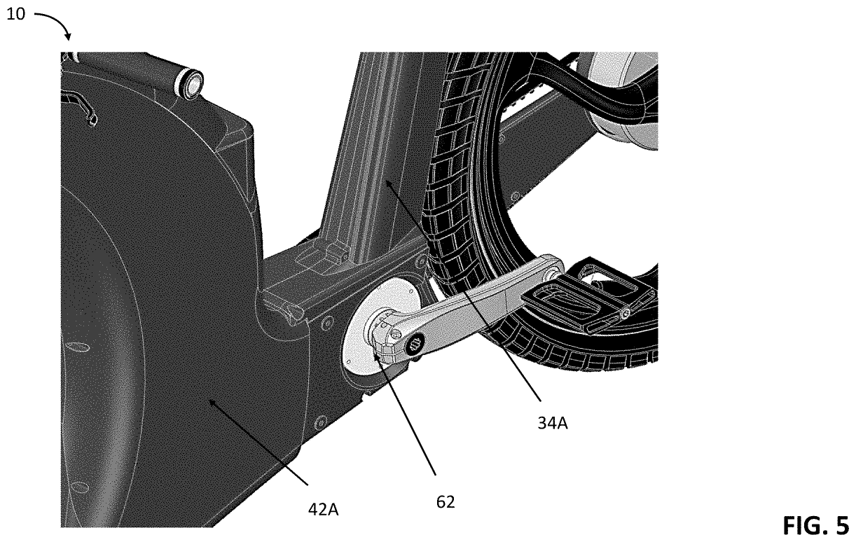

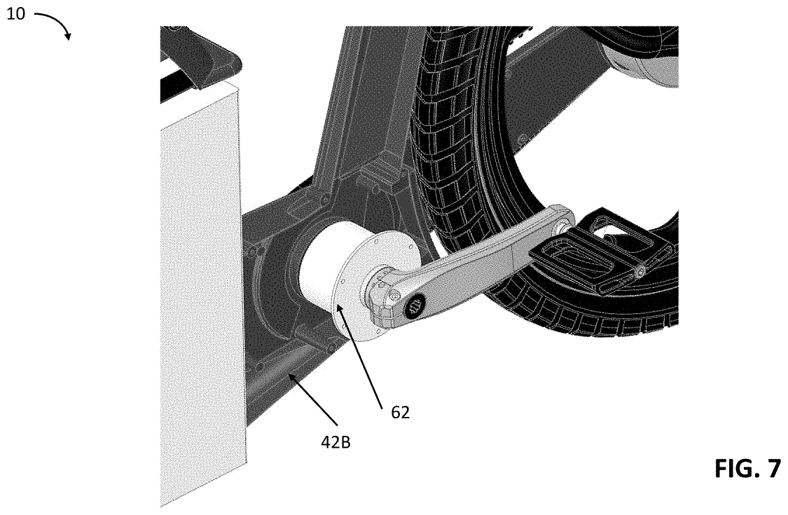

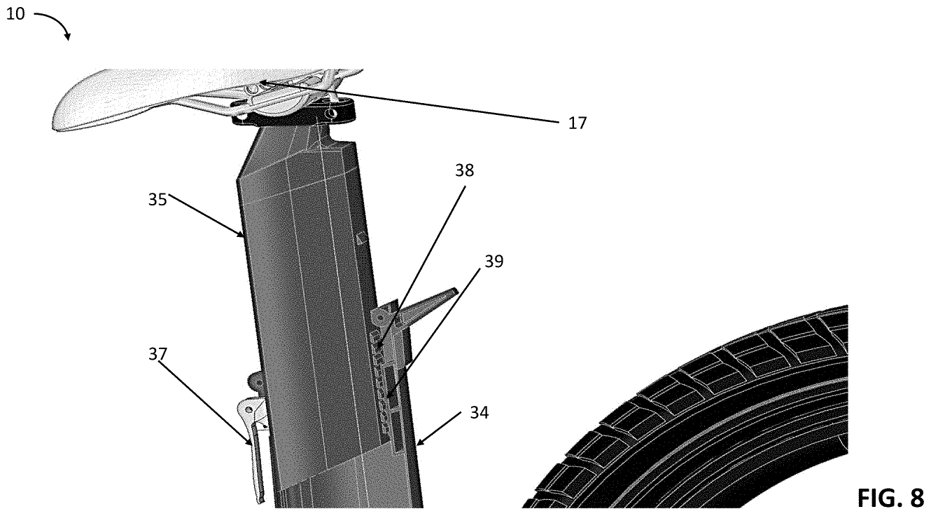

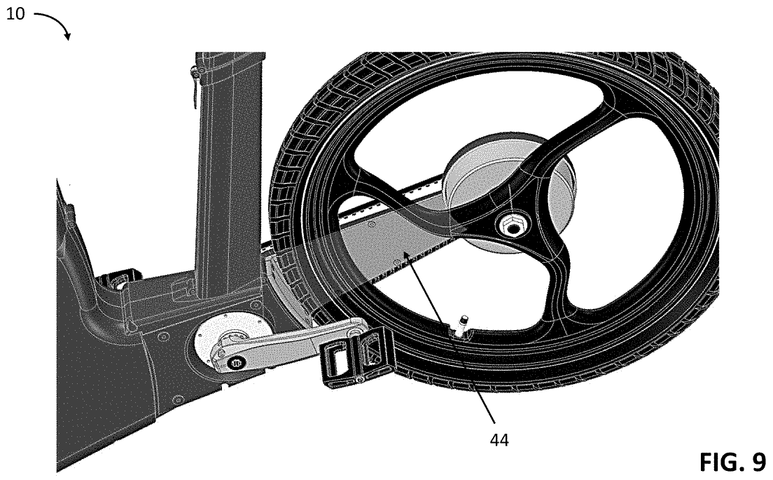

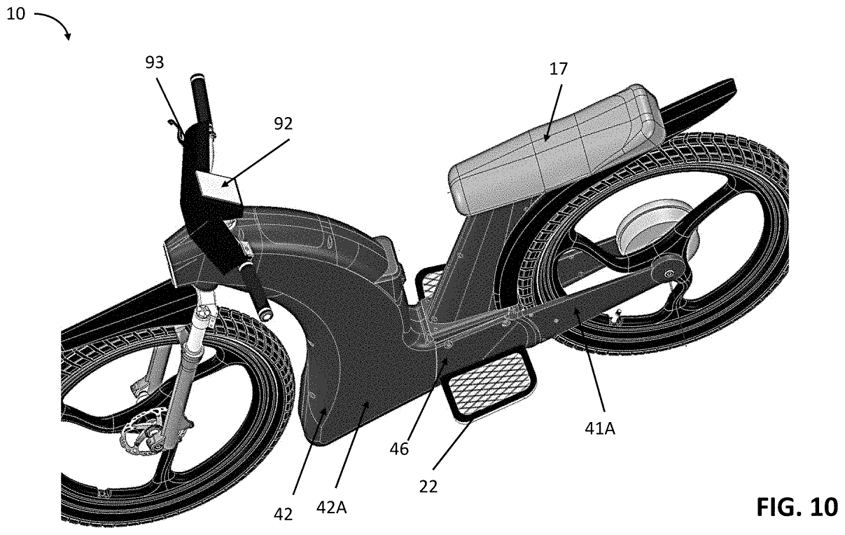

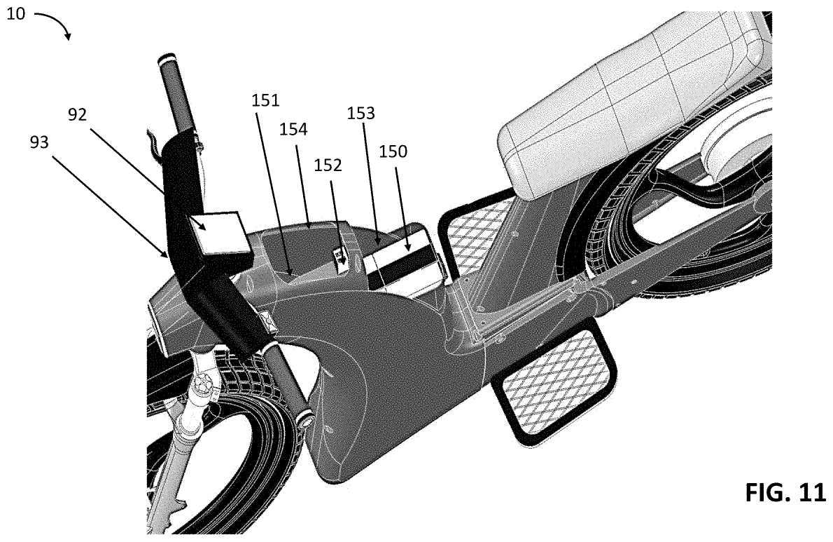

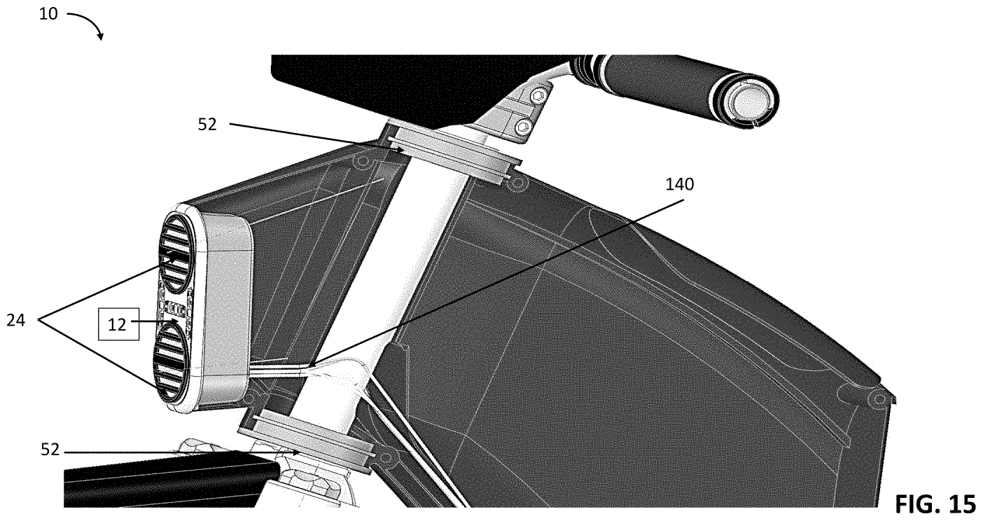

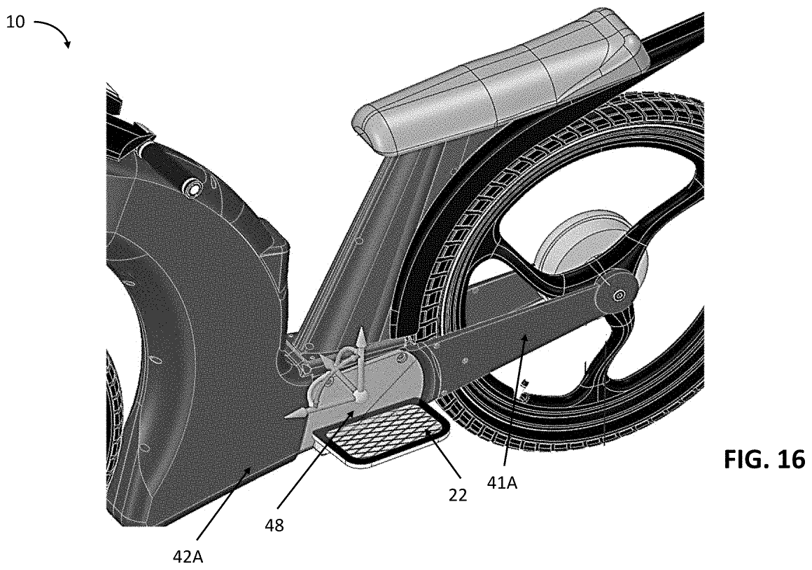

FIGS. 1-16 illustrate exemplary electric saddle type vehicles with a chassis 42 that can support a saddle type vehicle that can have both a pedaled configuration and a non-pedaled configuration. FIGS. 1 and 10-16 illustrate non-pedaled configurations of an electric saddle type vehicle 10 while FIGS. 2-9 illustrate the pedaled configuration of electric saddle type vehicle 10. As shown in FIG. 1, the electric saddle type vehicle 10 may have a chassis 42 having a forward end 13 and a rear end 15 opposite the forward end 13, where the chassis 42 includes a first side frame member 42B extending from the forward end 13 to the rear end 15 and a second side frame member 42A. The first (or right) side frame member 42B may include a forward portion that is forward of the steering stem 60, a first portion of a seat support tower 34B, and a first frame extension member 41B at the rear end 15 of the chassis 42, where the rear wheel 18 is attached to the first frame extension member 41B. The second (or left) side frame member 42A may include a forward portion that is forward of the steering stem 60, a second portion of a seat support tower 34A, and in some examples a second frame extension member 41A that attaches to the rear wheel 18. The first side frame member 42B and the second side frame member 42A may connect together to form a battery compartment 150, a storage compartment 151, and the seat support tower 34. In addition, the both side frame members 42A, 42B may include a portion of a forward recess 28 that is configured to receive a removable light and speaker module 12. The forward recess 28 may be formed from the first side frame member 42B and the second side frame member 42A, where the forward recess is located forward of the steering stem 60. The steering stem 60 may be attached near the forward end 13 of the chassis 42 and handlebars 43 may be attached to the steering stem 60. As discussed above, separate upper and lower steering bearings or steering mount supports 52 that receive the steering stem 60 may be clamped between the two side frame members 42A, 42B to provide a durable engaging surface for the steering stem 60. The steering stem 60 may also be attached to a front suspension 14 that connects to the front wheel 16. In some examples, the rear wheel 18 may include an electric hub motor 20 that is attached to provide the power to propel the rear wheel 18, while in other examples, an electric motor may be secured within an interior of the chassis 42. A rear fender 19 may releasably attach to the chassis 42 and extend over the rear wheel 18. Both of the first side frame member 42B and the second side frame member 42A may each be single unitary members that are cast, molded, or formed such that when the two side frame members 42A and 42B are joined together, they form the majority of the exterior surfaces of the chassis 42. For example, the first side frame member 42B may be formed as a single unitary member that includes the portion of the forward recess 28, a portion of the receivers 53 for the steering mount supports 52, a portion of the seat support tower 34B, and a frame extension member 41B to support the rear wheel 18. Similarly, the second side frame member 42A may be formed as a single unitary member that includes the portion of the forward recess 28, a portion of the receivers 53 for the steering mount supports 52, and a portion of the seat support tower 34A. In some examples, a frame extension member 41A may be integrally formed with the second side frame member 42A or in other examples, the frame extension member 41A may be releasably connected to the second side frame member 42A. Similarly, in some examples, the first frame extension member 41B may be releasably connected to the first side frame member 42B. Throughout this specification, the term releasably connected may include attaching components together such that the components can be separated without damaging the connected components. The releasable connection may be formed using mechanical fasteners, such as screws, or other releasable connections such as snap fits known to one skilled in the art.

The vehicle 10 may include a rear wheel hub motor 20 or a belt or chain drive motor and transmission if desired for the pedaled configuration to form an electric assisted pedal vehicle as known to one skilled in the art. In some examples, the chassis 42 may have a single sided frame extension member 41B that may be formed integrally with the first side frame member 42B that goes back along only one side of the rear wheel 18. The electric motor stator may be mounted to the rear of the frame extension member 41B, as may be the rear axle on which the rear wheel 18 and electric motor 20 rotate. In the case of a pedaled configuration, the rear hub motor 20 may have has provisions for a pedal driven rear sprocket to drive the rear wheel 18 either in fixed gear or with a transmission inside the rear wheel hub. In some examples, an additional frame extension member 41A, which may be integrally formed or removably attached to second side frame member 42A to provide for additional strength and stiffness in higher powered versions or vehicles subjected to rough use. When only one frame extension member is used, a frame extension cover 44 may mount to an inward facing surface of either or both frame extension members 41A, 41B and may also cover a recess or opening on the inward facing surface of the respective frame extension member 41A, 41B.

The chassis 42 may be modular and act as a frame for either a pedaled configuration or non-pedaled configuration of the electric saddle type vehicle. Each side frame member 42A, 42B may be configured such that when joined together form an opening to receive a have an opening to receive a pedal assembly 62 that has a crank arm 61 and pedals 23. The chassis 42 may also provide locations to connect all necessary component for a pedal assist electric vehicle 10 such as a forward sprocket 63, chain or belt 64, and a rear sprocket 65. The pedal assembly 62 may also include a cartridge with concentrically mounted electric motor and bearings to provide the power to the rear wheels through the chain 64. To have a common frame for the pedaled and non-pedal driven configuration, the pedal assembly 62 and bearings may be removed as a cartridge and the chassis 42 may have mounts to removably attach foot boards 22 and foot board plates 46 to cover the openings in the chassis 42 that receive the pedal assembly 62 when in the non-pedaled configuration.

In addition, when the side frame members 42A, 42B are joined to form the chassis 42, the chassis 42 may include a generally hollow interior such that the outer walls of the frame members carry the primary loads of the vehicle 10. As part of the hollow interior, the chassis 42 may include a battery compartment 150 and a storage compartment 151. Each side frame member 42A, 42B may include portions of wall members to form keep the storage compartment separate from the battery compartment. The battery compartment 150 may be located aft of and in some examples adjacent to the storage compartment 151. The storage compartment 151 may be located aft of the steering column 60. The battery compartment 150 may be accessed through a battery compartment opening 153 on an upper surface of the chassis 42. A battery compartment door 50 may be rotatably attached to the chassis 42 to cover the battery compartment 150 and provide selective access to the battery 110 or RESS when needed. Similarly the storage compartment 151 may be accessed through a storage compartment opening 154 on an upper surface of the chassis 42. A storage compartment door 51 may be rotatably attached to the chassis 42 may act to cover the storage compartment 151 and provide selective access to the storage compartment 151 when needed. The storage compartment door 51 may have a locking mechanism and in some examples, may be removable. Low voltage electric connections 152 for convenience, such as USB ports may be mounted inside the storage compartment 151.

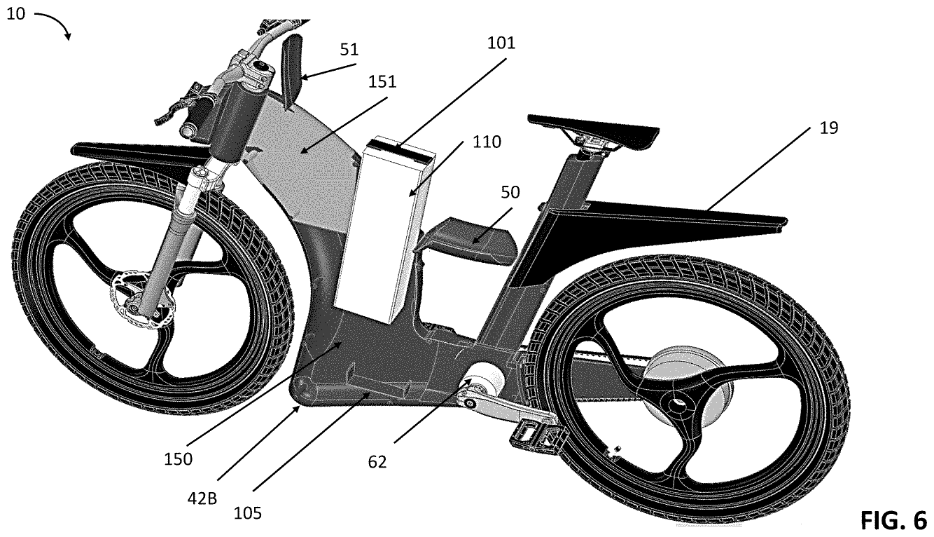

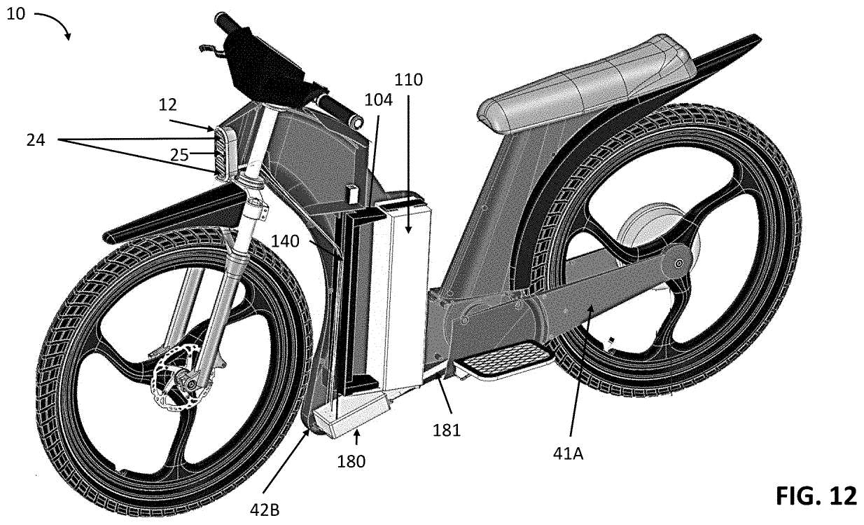

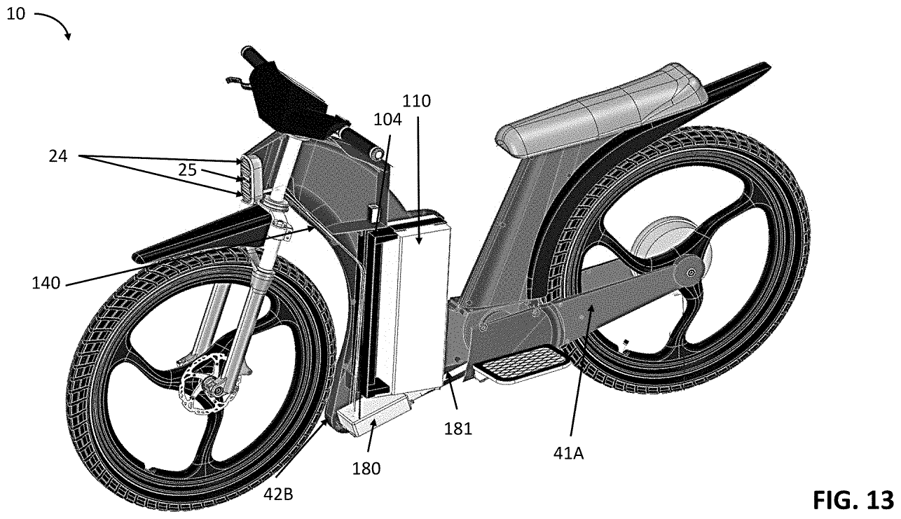

To power the electric motor 20, a battery 110 or RESS may be mounted in the battery compartment 150 by installing the RESS 110 through the battery compartment opening 153 as shown in FIG. 6. As shown in FIGS. 6 and 12-14, the battery compartment 150 may receive different sizes of batteries 110 or a plurality of batteries 110. In some examples such as those shown in FIGS. 12 and 13, the battery 110 may be attached to a spacer 104 to help align and ensure the battery 110 fits securely in the battery compartment. The size of the spacer 104 may depend on the size of the battery 110 to ensure the battery is properly secured within the battery compartment 150. The battery 110 may rest in a battery support frame located within the battery compartment 150. In some configurations, a plurality of batteries 110 may be connected together and secured within the battery compartment 150.

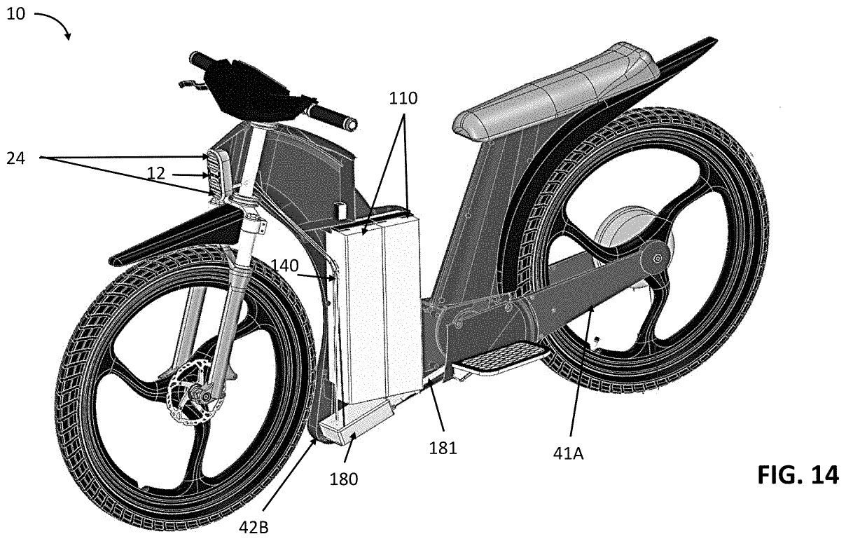

As discussed above, the battery compartment 150 allows the use of several different battery capacities. The batteries 110 may generally have a rectangular shape with longest measurement being vertical that allows these batteries to be loaded into the compartment 150 through opening 153 on top of the frame 42. The battery compartment door 50 may be a locking mechanism to prevent unauthorized access and may be a completely removable cover or a rotatably attached door 50. Each battery 110 may have a handle 101 on top to allow a user to easily lift the battery 110 for re-charge or exchange. When more than one battery 110 is installed, such as the example in FIG. 14, a safety switch may be provided to shut off the power to the battery electrical connection points until all batteries 110 are installed and the connection points are covered. In addition, an electronics module 180 that controls the operation of the vehicle 10 along with managing the power to the motor 20 may be located within the chassis 42 below the battery compartment 150. The side frame members 42A, 42B may include integrated internal mounting bosses and/or supports for the various electrical components, such as the electronics module 180 and low voltage electrical connections 152, the components may be protected from damage, but also accessible to be serviced.

The chassis 42 may also provide a conduit or channel 181 to allow the wiring 140 and brake lines to be routed from the handlebars 43 to the hollow steering stem 60, where the wiring 140 and brake lines to exit the steering stem 60 through an opening in the steering stem 60 into an internal cavity of the chassis 42. Specific shaping of ribs inside the frame 42 may help to route wires 140 to minimize chafing. A handlebar cover 93 may be mounted over the handlebars 43 to protect the wiring 140 and the brake lines attached to the handlebars 43 to organize and protect wires and hoses from outside accidental damage or vandalism. The handlebars may also include a visual display 92 to convey information to the rider 67.

The seat support tower 34 may also be formed when the two side frame members 42A, 42B are joined. The seat support tower 34 may support the seat 17 and in some examples, may receive a first insert to provide a bicycle type seat 17 for a pedaled configuration as shown in FIGS. 2-9. In the pedaled configuration, the seat support tower 34 may have an adjustable seat height for different rider sizes, where an inner seat stem 35 may be latched in place to the seat support tower 34 using a seat latch lever 37 helps to engaging teeth 38 on the inner seat stem 35 and engaging teeth 39 on the seat support tower 34. When in the pedaled configuration, the seat support tower 34 may receive a second insert to provide a motorcycle seat 17 for non-pedaled configuration as shown in FIGS. 1 and 10-16. On the non-pedaled configuration, the seat 17 may be elongated include room for a passenger.

As another feature, a removable headlight and speaker module 12 may be received in the forward recess 28 of the chassis 42. The removable headlight and speaker module 12 may include a plurality of speakers 24 along with a forward facing light source 25 and a separate battery (not shown) to power the module 12 when disconnected from the vehicle. The module 12 may also include a wireless receiver and transmitter, such as Bluetooth or similar means, to communicate with a handheld device or other transmitting device, such as a smartphone, to allow a user to play music through the speakers. In addition, when the vehicle 10 is moving or in operation, the speakers 24 may act as a horn or provide an audible tone or warning noise to as a safety feature to allow pedestrians or others to hear the vehicle 10 as it approaches, since the silence of electric vehicles can sometimes be hazardous in busy urban areas. In addition, the module may include a housing 30 and a connector to releasably connect to the electrical system of the vehicle 10. The light sources 25 may include multiple LED light sources.

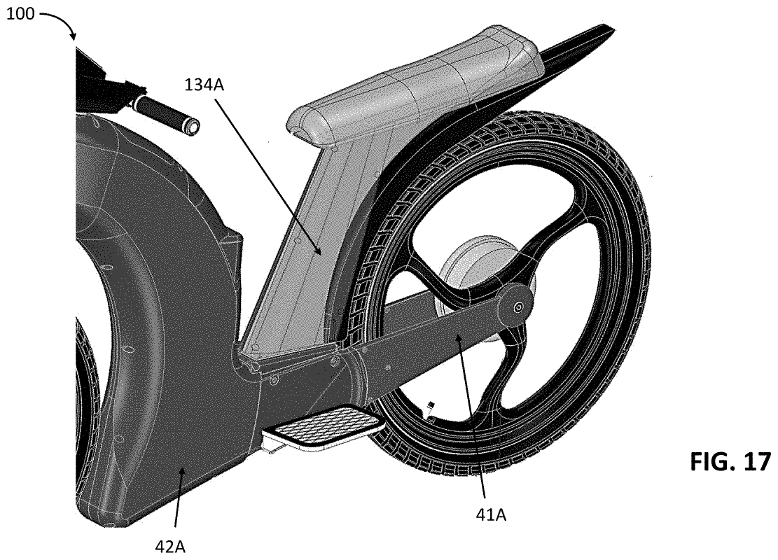

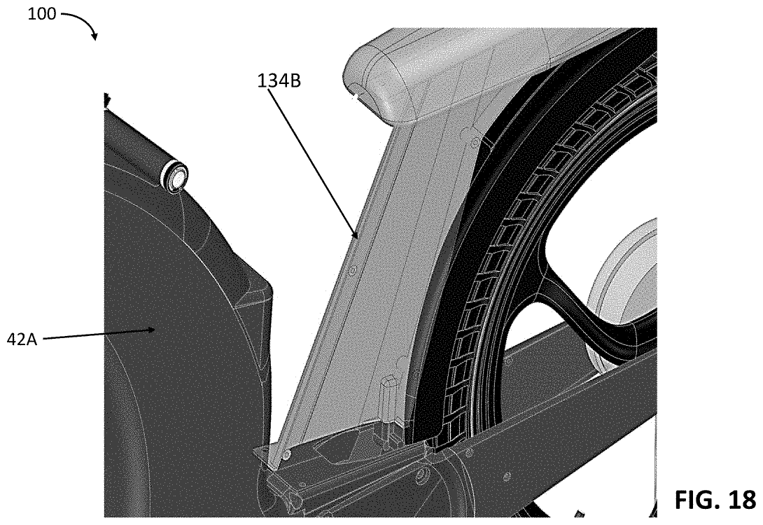

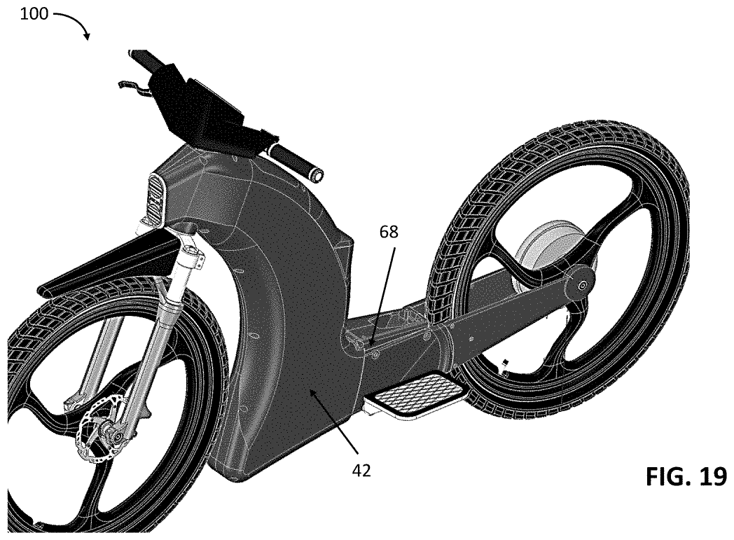

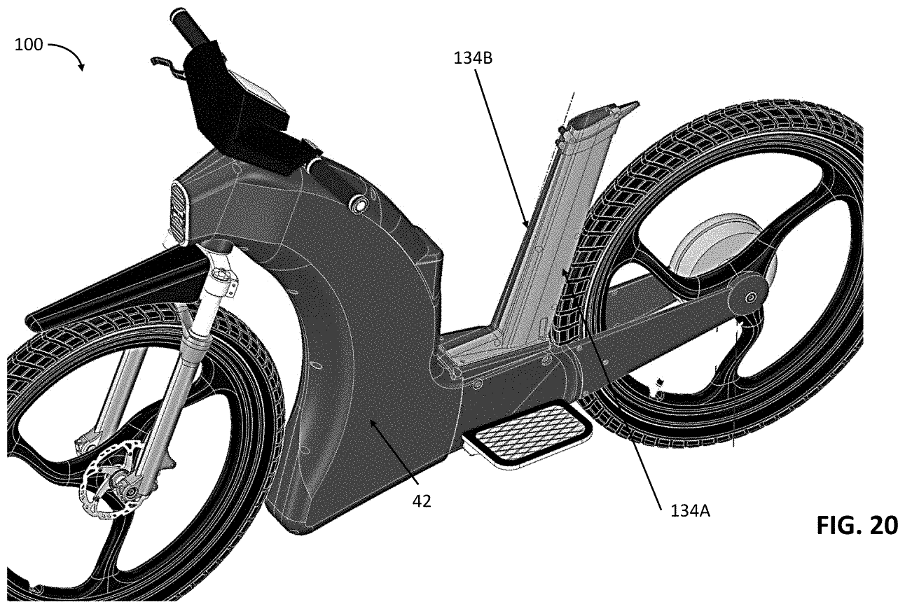

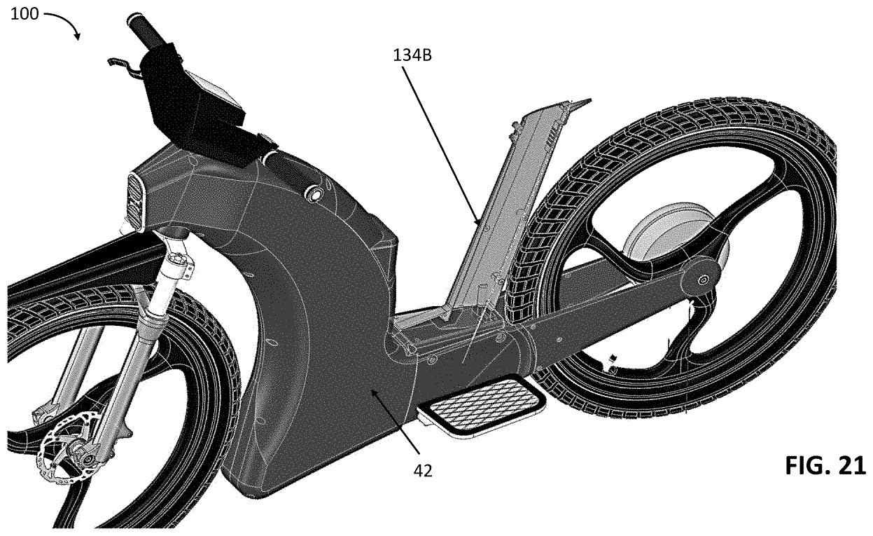

FIGS. 17-21 illustrate an alternative chassis 42 for an electric saddle type vehicle 100. In the embodiments of FIG. 17-21, the features are referred to using similar reference numerals as the examples of FIGS. 1-16. Accordingly, certain features of the chassis 42 already described above may be described in lesser detail, or may not be described at all. The chassis 42 of the example vehicle 100 may be formed of similar side frame members 42A, 42B as the examples of FIGS. 1-16 except the side frame members 42A, 42B are formed without the integrally formed respective seat support tower portions 34A, 34B. In the examples of FIGS. 17-21, the side frame members 42A, 42B when connected together may form a seat support mounting area 68 that receive separate seat support tower members 134A, 134B. The seat support tower members 134A, 134B may be releasably mounted to the chassis 42 at the seat support mounting area 68. In this example, the seat support tower 134 may be different for the pedaled configuration than the non-pedaled configuration.

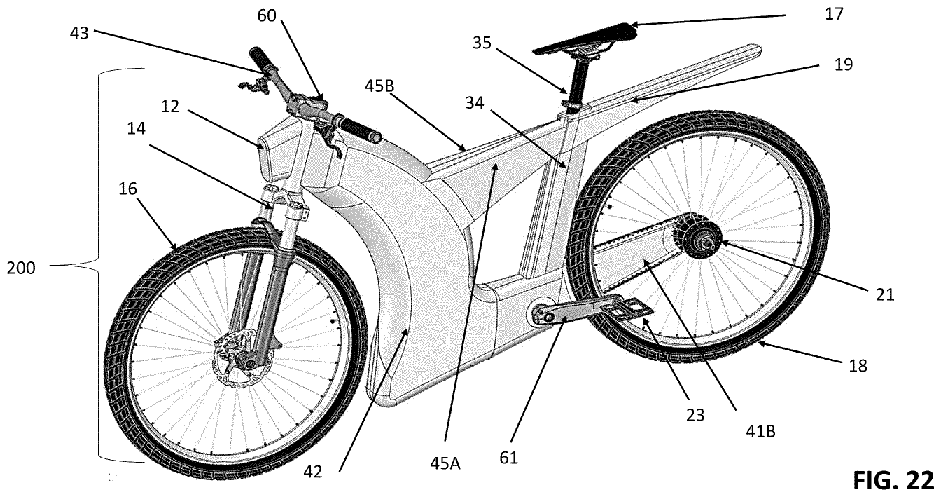

FIG. 22 illustrates another alternative chassis 42 for an electric saddle type vehicle 200. In the example of FIG. 22, the features are referred to using similar reference numerals as the examples of FIGS. 1-16. Accordingly, certain features of the chassis 42 already described above may be described in lesser detail, or may not be described at all. The chassis 42 of the example vehicle 200 may be formed of similar side frame members 42A, 42B as the examples of FIGS. 1-16 except the side frame members 42A, 42B are integrally formed with respective additional upper frame sections 45A, 45B. Each upper frame section 45A, 45B may extend between a forward portion of the each side frame member 42A, 42B near the battery compartment 150 to their respective seat support tower portion 34A, 34B of the each side frame member 42A, 42B to form a chassis 42 that is not a “step through” design. In addition, vehicle 200 illustrates a pedaled configuration with wire spoke wheels with a rear wheel hub 21 attached to the frame extension member 41B.

Listing of Reference Numbers:

| | |
|---|---|
| 10 | Saddle Type Vehicle |
| 12 | Light/Speaker Module |
| 13 | Front end of chassis |
| 14 | Front suspension |
| 15 | Rear end of chassis |
| 16 | Front wheel |
| 17 | Seat |
| 18 | Rear wheel |
| 19 | Rear fender |
| 20 | Rear wheel hub motor |
| 21 | Rear wheel hub |
| 22 | Foot pegs/Foot boards |
| 23 | Pedal |
| 24 | Speakers |
| 25 | Headlight |
| 28 | Forward recess |
| 30 | Light/Speaker Module Housing |
| 34 | Seat support tower |
| 34A | Seat support tower portion on Second |
| | Side Frame member |
| 34B | Seat support tower portion on First |
| | Side Frame member |
| 35 | Seat inner stem |
| 37 | Seat latch lever |
| 38 | Inner seat post latch teeth |
| 39 | Outer seat post latch teeth |
| 41 | Frame Extension Member |
| 41A | Second Frame Extension Member |
| 41B | First Frame Extension Member |
| 42 | Chassis/Frame |
| 42A | Second (Left) side frame member |
| 42B | First (Right) side frame member |
| 43 | Handlebars |
| 44 | Rear frame extension cover |
| 45A | Second upper frame member |
| 45B | First upper frame member |
| 46 | Foot board plate |
| 50 | Battery door |
| 51 | Storage door |
| 52 | Steering mount support |
| 53 | Receivers for Steering mount supports |
| 60 | Steering stem |
| 61 | Crank Arm |
| 62 | Pedal assembly |
| 63 | Front sprocket |
| 64 | Chain or Belt |
| 65 | Rear sprocket |
| 67 | Rider |
| 68 | Seat Support Mounting Area |
| 92 | Visual Display |
| 93 | Handle bar cover |
| 100 | Electric Saddle Type Vehicle |
| 101 | Battery Handle |
| 104 | Battery Spacer |
| 105 | Battery/RESS Support |
| 110 | Battery/RESS |
| 134A | Seat Tower, Second (Left) Side |
| 134B | Seat Tower, First (Right) Side |
| 140 | Wiring |
| 150 | Battery compartment |
| 151 | Storage compartment |
| 152 | Low voltage electrical connections |
| 153 | Battery compartment opening |
| 154 | Storage compartment opening |
| 180 | Electronics Module |
| 181 | Conduit structure |
| 200 | Electric Saddle Type Vehicle |

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims.

We claim:

1. An electric saddle type vehicle comprising:
a chassis having a forward end and a rear end opposite the forward end, the chassis including:
a first side frame member extending from the forward end to the rear end, wherein the first side frame member includes a first portion of a seat support tower, and a first frame extension member at the rear end of the chassis;
a second side frame member extending from the forward end to the rear end, wherein the second side frame member includes a second portion of the seat support tower,
wherein the first side frame member and the second side frame member connect together to form a battery compartment, a storage compartment, and the seat support tower;
a steering stem attached near the forward end of the chassis, wherein handlebars are attached to the steering stem; and
a rear wheel attached to the rear end of the chassis.

2. The electric saddle type vehicle of claim 1, wherein the rear wheel is connected to an electric hub motor.

3. The electric saddle type vehicle of claim 1, wherein the first side frame member is a unitary single member and the second side frame member is a unitary single member.

4. The electric saddle type vehicle of claim 1, wherein steering mount supports are secured in between the first side frame member and the second side frame member when the first side frame member and the second side frame member are connected together, wherein the steering mount supports receive the steering stem.

5. The electric saddle type vehicle of claim 1, wherein the battery compartment is accessed through a battery compartment opening on a top surface of the chassis.

6. The electric saddle type vehicle of claim 1, wherein a storage compartment is accessed through a storage compartment opening on a top surface of the chassis.

7. The electric saddle type vehicle of claim 6, wherein a battery or rechargeable energy storage system is mounted in the battery compartment by installing the rechargeable energy storage system through the battery compartment opening, and wherein a battery compartment cover is secured over the battery compartment opening.

8. The electric saddle type vehicle of claim 7, wherein a spacer is attached to the battery or rechargeable energy system prior to the battery being installed into the battery compartment.

9. The electric saddle type vehicle of claim 1, wherein the forward end of the chassis has a forward recess formed from the first side frame member and the second side frame member, wherein the forward recess is forward of the steering stem.

10. The electric saddle type vehicle of claim 9, wherein a removable headlight and speaker module is received in the forward recess.

11. The electric saddle type vehicle of claim 1, wherein the seat support tower receives a first insert to provide a bicycle type seat for a pedaled configuration, and the seat support tower receives a second insert to provide a motorcycle seat for a non-pedaled configuration.

12. The electric saddle type vehicle of claim 1, wherein wiring and brake lines are routed from the handlebars to the steering stem, wherein the wiring and the brake lines exit the steering stem through an opening in the steering stem into a channel arranged in an internal cavity of the chassis.

13. The electric saddle type vehicle of claim 12, wherein a handlebar cover is mounted over the handlebars to protect the wiring and the brake lines attached to the handlebars.

14. An electric saddle type vehicle comprising:
a chassis having a forward end and a rear end opposite the forward end, wherein the rear end extends aft of a seat, the chassis being configured to support a pedaled configuration and a non-pedaled configuration of the electric saddle type vehicle and including:
a first side frame member extending from the forward end to the rear end, wherein the first side frame member includes a first portion of a seat support mounting area and a first frame extension member;
a second side frame member extending from the forward end to the rear end, wherein the first side frame member includes a second portion of the seat support mounting area;
wherein the first side frame member and the second side frame member connect together to form a battery compartment, a storage compartment, and the seat support mounting area; and
a steering stem attached near the forward end of the chassis.

15. The electric saddle type vehicle of claim 14, wherein the first frame extension member is releasably attached to the first side frame member, and wherein the first frame extension member connects to an electric hub motor and a rear wheel.

16. The electric saddle type vehicle of claim 15, a frame extension member cover connects to the first frame extension member that covers a recess on an inward facing surface of the frame extension member.

17. The electric saddle type vehicle of claim 14, wherein when the chassis is configured in the pedaled configuration, a cartridge containing a pedal shaft and bearings is connected to the chassis.

18. The electric saddle type vehicle of claim 17, wherein the cartridge includes a concentrically mounted electric motor.

19. The electric saddle type vehicle of claim 14, wherein the seat is supported by a seat support tower that is releasably connected to the chassis at the seat support mounting area, and wherein the seat support tower is formed from a first seat support tower member and a second seat support tower member.

20. The electric saddle type vehicle of claim 19, wherein the seat support tower is different for the pedaled configuration than the non-pedaled configuration.
